(19) United States
(12) Patent Application Publication
(10) Pub. No.: US 2003/0105751 A1
(43) Pub. Date: Jun. 5, 2003

(54) Client-oriented information system

(76) Inventor: R.E. van Domburg, Harderwijk (NL)

Correspondence Address: SWIDLER BERLIN SHEREFF FRIEDMAN, LLP, 3000 K STREET, NW, BOX IP, WASHINGTON, DC, 20007, US

(21) Appl. No.: 10/289,177

(22) Filed: Nov. 7, 2002

(30) Foreign Application Priority Data
Nov. 22, 2001 (EP) 01204458.2

(51) Int. Cl. G06F 7/00

(52) U.S. Cl. 707/3

(57) ABSTRACT

A system, method, and computer program product for displaying information that provides the capability to navigate and specify information more quickly and more easily than existing systems. A client-oriented information system comprises a computer, a display device connected to the computer and software operational on the computer for retrieval of information from a database, the software operable to display a navigational tree on the display device for supporting the information retrieval, wherein the navigational tree displayed on the display device embodies static and dynamic information.

### FIELD OF THE INVENTION

The present invention relates to a client-oriented information system for retrieval of information from a database, and in particular to software on the client-oriented information system that includes a navigational tree for supporting the information retrieval.

### BACKGROUND OF THE INVENTION

The use of information systems has become widespread in many industries and organizations. Information systems are used to enter, store, retrieve, and process information, and to generate reports about that information. Existing information systems are bothersome to use by reason that such known systems require laborious navigation in order to retrieve the required information and in order to input information into the system for reporting or for later use. For example, many information systems require the entry of numerous commands to navigate to and specify the required information. Likewise, other information systems require the selection of numerous pages or screens in order to navigate to and specify the required information. Such navigation and specification is time-consuming to use and is prone to introducing errors in the use of the information system.

A need arises for a technique for navigating to and specifying information in an information system that is quicker and easier to use than existing systems.

### SUMMARY OF THE INVENTION

The present invention is a system, method, and computer program product for displaying information that provides the capability to navigate and specify information more quickly and more easily than existing systems.

In one embodiment of the present invention, a client-oriented information system comprises a computer, a display device connected to the computer and software operational on the computer for retrieval of information from a database, the software operable to display a navigational tree on the display device for supporting the information retrieval, wherein the navigational tree displayed on the display device embodies static and dynamic information. The static information may relate to one or more clients and the dynamic information relates to jobs or tasks performed or to be performed on behalf of such clients. The navigational tree may be accessible at a preselected level of static information below a top level.

In one embodiment of the present invention, a method of displaying information comprises the steps of retrieving information from a database, displaying the retrieved information in a navigational tree including static and dynamic information, receiving input relating to items of information displayed in the navigational tree, retrieving information from the database relating to the items of information for which input has been received, and displaying the retrieved information relating to the items of information for which input has been received in the navigational tree. The static information may relate to one or more clients and the dynamic information relates to jobs or tasks performed or to be performed on behalf of such clients. The navigational tree may be accessible at a preselected level of static information below a top level.

In one aspect of the present invention, the database may be included in an information system performing the method or the database may be external to an information system performing the method.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary display incorporating the present invention.

FIG. 2 is an exemplary diagram of a navigational tree shown in FIG. 1.

FIG. 3 is a block diagram of an exemplary information system, in which the present invention may be implemented.

FIG. 4 is a process of interaction between a DBMS and a navigational tree.

### DETAILED DESCRIPTION OF THE PREFERRED EMBODIMENTS

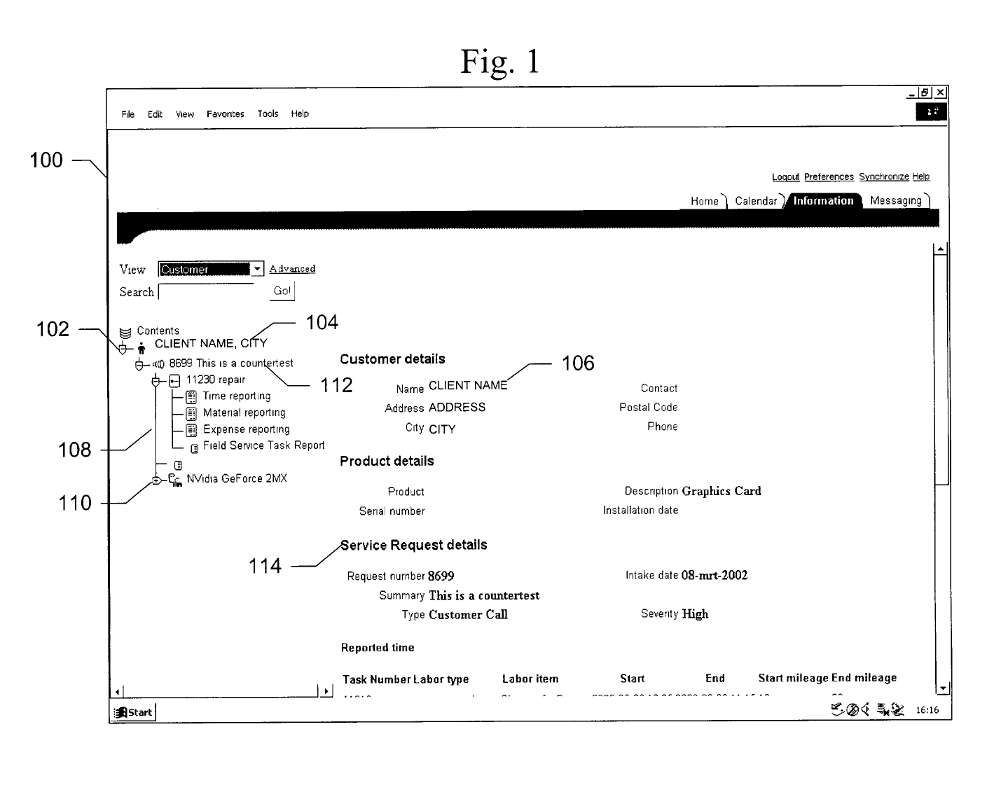

An exemplary display 100 incorporating the present invention is shown in FIG. 1. Display 100 is a pictorial representation of information, which may be displayed on a display device, such as a monitor or liquid-crystal display device. Display 100 includes navigational tree 102, which includes both static information and dynamic information.

Navigational tree 102 of the system may display both static and dynamic information that are interrelated and are shown in combination. For example, information displayed in navigational tree 102 may include top-level information 104, which, in this example, pertains to the client “Client Name” located in “City”. Similar information 106 with reference to this client may also be displayed elsewhere in more detail. Navigational tree 102 may also display other information 108 relating to the top-level information. Further details of each item of information and/or information relating to other items may be provided in the same navigational tree. This information is dynamic in the sense that the navigational tree can be expanded with any further items that one wishes to include. In addition, the display of the items in navigational tree 102 is dynamic and can be controlled by the operation of displayed navigational controls, such as control 110. Typically, such displayed navigational controls may be operated by positioning a cursor over the control and depressing a button, such as the button of a mouse or other pointing device.

In addition, the display of other information is dynamic. For example, information 112 relating to a particular item in navigational tree 102, such as service request, is shown in navigational tree 102 and similar and/or additional information 114 relating to this item may be displayed elsewhere.

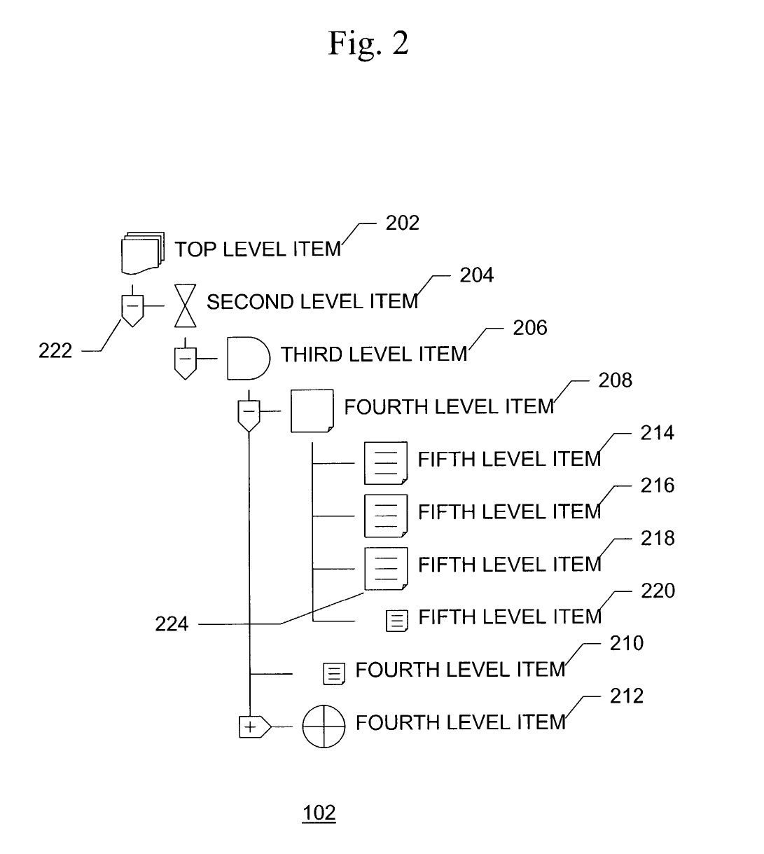

An exemplary diagram of a navigational tree 102 is shown in FIG. 2. In the example shown in FIG. 2, navigational tree 102 includes top level item 202, one or more second level items, such as second level item 204, one or more third level items, such as item 206, one or more fourth level items, such as items 208, 210, and 212, and one or more fifth level items, such as items 214, 216, 218, and 220. Navigational tree 102 of the system may display both static and dynamic information that are interrelated and are shown in combination. For example, information displayed in navigational tree 102 may include top-level item 202. Similar information with reference to the top-level information may also be displayed elsewhere in more detail. Further details of top-level item 202 may be provided in the same navigational tree, for example, by lower level items. Likewise, further details of any item in navigational tree 102 may be provided in lower-level items associated with the item. This information is dynamic in the sense that the navigational tree can be expanded with any further items that one wishes to include. In addition, the display of the items in navigational tree 102 is dynamic and can be controlled by the operation of displayed navigational controls, such as control 222. Typically, such displayed navigational controls may be operated by positioning a cursor over the control and depressing a button, such as the button of a mouse or other pointing device.

The software supporting access to the data base embodying the information displayed provides quick access to any required level below the level being displayed. For example, if a user, when looking at a display of information relating to item 214, wishes to switch over to information concerning 218, this can be done by simply clicking on icon 224 associated with item 218.

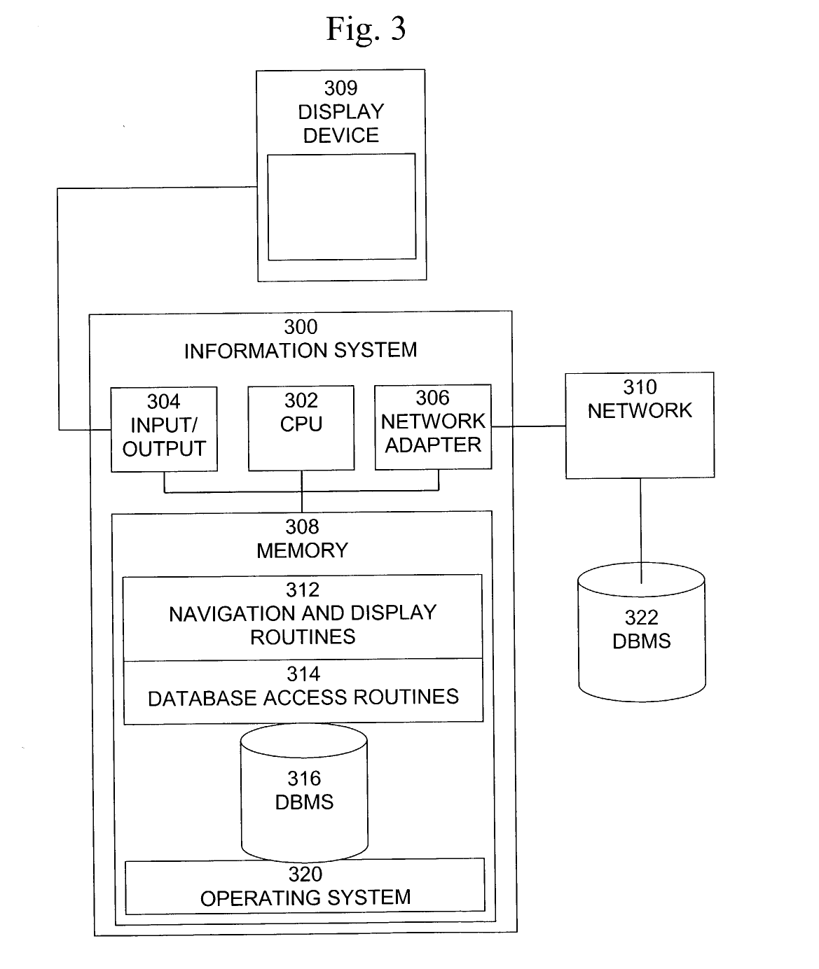

A block diagram of an exemplary information system 300, in which the present invention may be implemented, is shown in FIG. 3. Information system 300 is typically a programmed general-purpose computer system, such as a desktop or laptop personal computer, workstation, server system, and minicomputer or mainframe computer. Information system 300 includes processor (CPU) 302, input/output circuitry 304, network adapter 306, memory 308, and display 309. CPU 302 executes program instructions in order to carry out the functions of the present invention. Typically, CPU 302 is a microprocessor, such as an INTEL PENTIUM® processor, but may also be a minicomputer or mainframe computer processor. Although in the example shown in FIG. 3, information system 300 is a single processor computer system, the present invention contemplates implementation on a system or systems that provide multi-processor, multi-tasking, multi-process, multi-thread computing, distributed computing, and/or networked computing, as well as implementation on systems that provide only single processor, single thread computing. Likewise, the present invention also contemplates embodiments that utilize a distributed implementation, in which information system 300 is implemented on a plurality of networked computer systems, which may be single-processor computer systems, multi-processor computer systems, or a mix thereof.

Input/output circuitry 304 provides the capability to input data to, or output data from, information system 300. For example, input/output circuitry may include input devices, such as keyboards, mice, touchpads, trackballs, scanners, etc., output devices, such as video and/or other display adapters, printers, etc., and input/output devices, such as, modems, etc. Display device 309 is connected to input/output circuitry 304 and is used to display a pictorial representation of information, such as display 100, shown in FIG. 1, Display device 309 may be any type of device capable of displaying information, such as a monitor or liquid-crystal display device.

Network adapter 306 interfaces information system 300 with network 310. Network 310 may be any standard local area network (LAN) or wide area network (WAN), such as Ethernet, Token Ring, the Internet, or a private or proprietary LAN/WAN.

Memory 308 stores program instructions that are executed by, and data that are used and processed by, CPU 302 to perform the functions of the present invention. Memory 308 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

Memory 308 includes navigation and display routines 312, database access routines 314, and operating system 312. Navigation and display routines 312 include software routines that provide the capability to display and operate one or more navigation trees, such as navigation tree 102, shown in FIG. 1. Database access routines 314 provide the capability to access one or more databases, such as those included in database management system (DBMS) 316 or DBMS 322, in order to retrieve information for display. Operating system 312 provides overall system functionality.

DBMS 316 and DBMS 322 are examples of DBMSs with which the navigation trees may interact. DBMS 316 is an example of a DBMS that is included in information system 300, while DBMS 322 is an example of a DBMS that is external to information system 300. DBMS 322 is communicatively connected to information system 300, typically via a communications network, such as network 310. A DBMS provides the capability to store, organize, modify, and extract information from one or more databases included in the DBMS. From a technical standpoint, DBMSs can differ widely. The terms relational, network, flat, and hierarchical all refer to the way a DBMS organizes information internally. The internal organization can affect how quickly and flexibly you can extract information.

Each database included in a DBMS includes a collection of information organized in such a way that computer software can select and retrieve desired pieces of data. Traditional databases are organized by fields, records, and files. A field is a single piece of information; a record is one complete set of fields; and a file is a collection of records. An alternative concept in database design is known as Hypertext. In a Hypertext database, any object, whether it be a piece of text, a picture, or a film, can be linked to any other object. Hypertext databases are particularly useful for organizing large amounts of disparate information, but they are not designed for numerical analysis.

Typically, a database includes not only data, but also low-level database management functions, which perform accesses to the database and store or retrieve data from the database. Such functions are often termed queries and are performed by using a database query language, such as Structured Query Language (SQL). SQL is a standardized query language for requesting information from a database. Historically, SQL has been a popular query language for database management systems running on minicomputers and mainframes. Increasingly, however, SQL is being supported by personal computer database systems because it supports distributed databases (databases that are spread out over several computer systems). This enables several users on a local-area network to access the same database simultaneously.

Most full-scale database systems are relational database systems. Small database systems, however, use other designs that provide less flexibility in posing queries. Relational databases are powerful because they require few assumptions about how data is related or how it will be extracted from the database. As a result, the same database can be viewed in many different ways. An important feature of relational systems is that a single database can be spread across several tables. This differs from flat-file databases, in which each database is self-contained in a single table.

A DBMS may also include one or more database applications, which are software that implements a particular set of functions that utilize one or more databases. Examples of database applications include:

computerized library systems

automated teller machines

flight reservation systems

computerized parts inventory systems

Typically, a database application, includes data entry functions and data reporting functions. Data entry functions provide the capability to enter data into a database. Data entry may be performed manually, by data entry personnel, automatically, by data entry processing software that receives data from connected sources of data, or by a combination of manual and automated data entry techniques. Data reporting functions provide the capability to select and retrieve data from a database and to process and format that data for other uses. Typically, retrieved data is used to display information to a user, but retrieved data may also be used for other functions, such as account settlement, automated ordering, numerical machine control, etc.

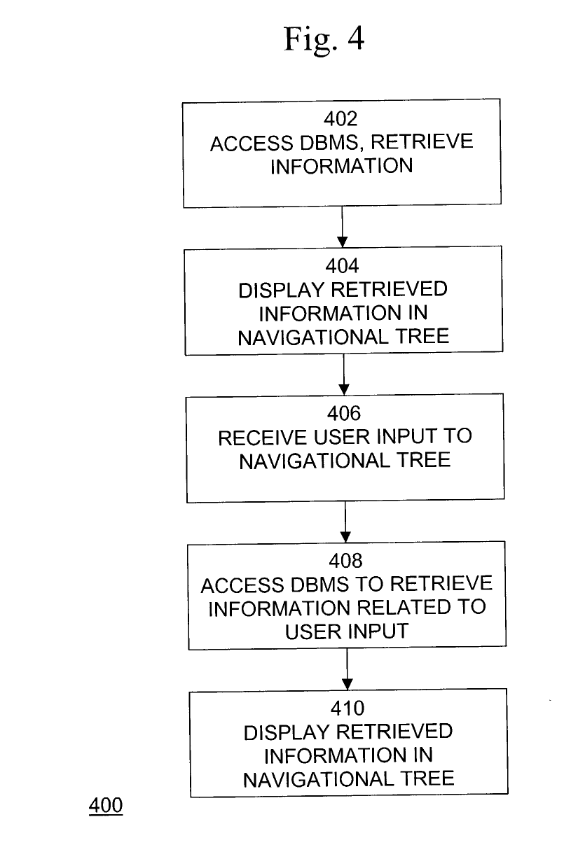

A process 400 of interaction between a DBMS and a navigational tree is shown in FIG. 4. Process 400 begins with step 402, in which the DBMS is accessed and information is retrieved. In step 404, the retrieved information is displayed. The information display include a navigational tree and may also include additional information and/or additional types of information displays. The navigational tree may display both static and dynamic information that are interrelated and are shown in combination. For example, information displayed in the navigational tree may include one or more top-level items and items of one or more lower levels. Information relating to other items may be provided by other top-level items. Further details of top-level items may be provided in the same navigational tree, for example, by lower level items. Likewise, further details of any item in the navigational tree may be provided in lower-level items associated with the item. This information is dynamic in the sense that the navigational tree can be expanded with any further items that one wishes to include. In addition, the display of the items in the navigational tree is dynamic and can be controlled by the operation of displayed navigational controls.

In step 406, user input relating to operation of displayed navigational controls is received. Typically, displayed navigational controls may be operated by positioning a cursor over the control and depressing a button, such as the button of a mouse or other pointing device. The software supporting access to the DBMS embodying the information displayed provides quick access to any required level below the level being displayed. For example, if a user, when looking at a display of information relating to an item wishes to switch over to information concerning another item, this can be done by simply clicking on an icon associated with the other item. In step 408, the DBMS is accessed and information relating to the item or items for which user input has been received is retrieved. In step 410, the retrieved information is displayed.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A client-oriented information system comprising a computer, a display device connected to the computer and software operational on the computer for retrieval of information from a database, the software operable to display a navigational tree on the display device for supporting the information retrieval, wherein the navigational tree displayed on the display device embodies static and dynamic information.

2. The information system of claim 1, wherein the static information relates to one or more clients and the dynamic information relates to jobs or tasks performed or to be performed on behalf of such clients.

3. The information system of claim 2, wherein the navigational tree is accessible at a preselected level of static information below a top level.

4. A method of displaying information comprising the steps of:
retrieving information from a database;
displaying the retrieved information in a navigational tree including static and dynamic information;
receiving input relating to items of information displayed in the navigational tree;
retrieving information from the database relating to the items of information for which input has been received; and
displaying the retrieved information relating to the items of information for which input has been received in the navigational tree.

5. The method of claim 4, wherein the static information relates to one or more clients and the dynamic information relates to jobs or tasks performed or to be performed on behalf of such clients.

6. The method of to claim 5, wherein the navigational tree is accessible at a preselected level of static information below a top level.

7. The method of claim 4, wherein the database is included in an information system performing the method.

8. The method of claim 7, wherein the static information relates to one or more clients and the dynamic information relates to jobs or tasks performed or to be performed on behalf of such clients.

9. The method of claim 8, wherein the navigational tree is accessible at a preselected level of static information below a top level.

10. The method of claim 4, wherein the database is external to an information system performing the method.

11. The method of claim 7, wherein the static information relates to one or more clients and the dynamic information relates to jobs or tasks performed or to be performed on behalf of such clients.

12. The method of to claim 8, wherein the navigational tree is accessible at a preselected level of static information below a top level.

13. A system for displaying information comprising:
a processor operable to execute computer program instructions;
a display device operable to display a representation of information;
a memory operable to store computer program instructions executable by the processor; and
computer program instructions stored in the memory and executable to perform the steps of:
retrieving information from a database;
displaying the retrieved information in a navigational tree including static and dynamic information;
receiving input relating to items of information displayed in the navigational tree;
retrieving information from the database relating to the items of information for which input has been received; and
displaying the retrieved information relating to the items of information for which input has been received in the navigational tree.

14. The system of claim 13, wherein the static information relates to one or more clients and the dynamic information relates to jobs or tasks performed or to be performed on behalf of such clients.

15. The system of to claim 14, wherein the navigational tree is accessible at a preselected level of static information below a top level.

16. The system of claim 13, wherein system further comprises the database.

17. The system of claim 16, wherein the static information relates to one or more clients and the dynamic information relates to jobs or tasks performed or to be performed on behalf of such clients.

18. The system of claim 17, wherein the navigational tree is accessible at a preselected level of static information below a top level.

19. The system of claim 13, wherein the system is communicatively connected to the database.

20. The system of claim 19, wherein the static information relates to one or more clients and the dynamic information relates to jobs or tasks performed or to be performed on behalf of such clients.

21. The system of to claim 20, wherein the navigational tree is accessible at a preselected level of static information below a top level.

22. A computer program product for displaying information in an information system, comprising:
a computer readable medium;
computer program instructions, recorded on the computer readable medium, executable by a processor, for performing the steps of:
retrieving information from a database;
displaying the retrieved information in a navigational tree including static and dynamic information;
receiving input relating to items of information displayed in the navigational tree;
retrieving information from the database relating to the items of information for which input has been received; and
displaying the retrieved information relating to the items of information for which input has been received in the navigational tree.

23. The computer program product of claim 22, wherein the static information relates to one or more clients and the dynamic information relates to jobs or tasks performed or to be performed on behalf of such clients.

24. The computer program product of to claim 23, wherein the navigational tree is accessible at a preselected level of static information below a top level.

25. The computer program product of claim 22, wherein the database is included in an information system including the computer program product.

26. The computer program product of claim 25, wherein the static information relates to one or more clients and the dynamic information relates to jobs or tasks performed or to be performed on behalf of such clients.

27. The computer program product of claim 26, wherein the navigational tree is accessible at a preselected level of static information below a top level.

28. The computer program product of claim 22, wherein the database is external to an information system including the computer program product.

29. The computer program product of claim 28, wherein the static information relates to one or more clients and the dynamic information relates to jobs or tasks performed or to be performed on behalf of such clients.

30. The computer program product of to claim 29, wherein the navigational tree is accessible at a preselected level of static information below a top level.
